(19) United States
(12) Patent Application Publication
(10) Pub. No.: US 2023/0225020 A1
(43) Pub. Date: Jul. 13, 2023

(54) HOB APPARATUS

(71) Applicant: BSH Hausgeräte GmbH, Munich (DE)

(72) Inventors: Laura Elena Valero, Regensburg (DE); Alejandro del Cueto Belchi, Zaragoza (ES); Jorge Felices Betran, Huesca (ES); Manuel Fernandez Martinez, Zaragoza (ES); Jose Miguel Gil Narvion, Zaragoza (ES); Pablo Jesus Hernandez Blasco, Zaragoza (ES); Eduardo Imaz Martinez, Tudela (Navarra) (ES); Paul Muresan, La Cartuja (ES); Jose Manuel Palacios Gasos, Zaragoza (ES); Alberto Perez Bosque, Zaragoza (ES); Diego Puyal Puente, Zaragoza (ES); Javier Serrano Trullen, Zaragoza (ES)

(21) Appl. No.: 18/007,757

(22) PCT Filed: Jul. 6, 2021
(86) PCT No.: PCT/EP2021/068641

§ 371 Date: Dec. 2, 2022

(30) Foreign Application Priority Data
Jul. 17, 2020 (EP) 20382652

(51) Int. Cl. H05B 6/12; H05B 6/06

(52) U.S. Cl. CPC H05B 6/1209; H05B 6/062

(57) ABSTRACT

A hob apparatus includes a heating unit, a sensor unit separate from the heating unit and configured to include an electric resonant circuit and to detect a sensor signal, and a control unit configured to control the sensor unit and to analyze the sensor signal. The control unit determines in an operating state a state variable relating to the heating unit based on a phase shift and/or an amplitude ratio between the sensor signal and a further signal.

The invention relates to a hob apparatus according to the preamble of claim 1 and a method for operating a hob apparatus according to the preamble of claim 12.

Induction hobs with sensors for detecting cookware are already known from the prior art. In some known embodiments a circuit made up of heating coils and inverters that is already present is used as a sensor for detecting cookware on the induction hob, in that it is concluded that cookware is present above the heating unit based on a change in an electrical parameter of the circuit, for example a change in inductance. In other known induction hobs from the prior art an additional separate sensor circuit is used to detect cookware, this also being known as a Colpitts oscillator. In addition to simply detecting the presence of cookware above a heating coil, this also allows a degree to which the cookware covers one or more heating coils to be detected, by measuring an oscillation frequency of the sensor circuit, which changes as a function of the material of the cookware and/or the degree of cover by the cookware. The electromagnetic fields generated by the heating coils during operation can result in unwanted interactions with the sensor circuit and therefore detection errors. In the known apparatuses with a separate sensor circuit therefore reasonably reliable detection is only possible when there is a period of zero passage of mains AC voltage, due to the reduced electromagnetic interactions between the heating coil and the sensor circuit during such a period. This prevents continuous detection. With known induction apparatuses, which are designed for the simultaneous operation of several heating coils by way of a number of external conductors of a mains connection with mains AC voltages that are phase-offset in relation to one another, the phase offset means that amplified electromagnetic interactions result with adjacent heating coils operated in a phase-offset manner even during zero passage of a phase, with the result that there is a greater tendency to error during the detection of cookware.

The object of the invention is in particular, although without restriction thereto, to provide a generic apparatus with improved properties in respect of operating convenience. The object is achieved according to the invention by the features of claims 1 and 12, while advantageous embodiments and developments of the invention will emerge from the subclaims.

The invention is based on a hob apparatus, in particular an induction hob apparatus, having at least one heating unit, at least one sensor unit that is separate from the heating unit, has at least one electric resonant circuit and is provided for detecting at least one sensor signal, and having a control unit, which is provided for controlling the sensor unit and analyzing the sensor signal.

It is proposed that in an operating state the control unit determines at least one state variable relating to the heating unit based on a phase shift and/or an amplitude ratio between the sensor signal and a further signal.

Such an embodiment advantageously improves operating convenience and/or the operating experience for a user. It advantageously allows particularly reliable, in particular less failure-prone, and/or accurate detection of the sensor signal and therefore particularly reliable and accurate determination of the state variable relating to the heating unit, for example the presence of cookware on a hob plate above the heating unit and/or a degree of cover of a heating element of the heating unit by the cookware. Because the state variable relating to the heating unit is determined by the control unit based on a phase shift and/or an amplitude ratio between the sensor signal and the further signal, the accuracy of the determined state variable can advantageously be further increased. As the sensor unit is separate from the heating unit, detection errors due to electromagnetic interactions with the heating unit can advantageously be reduced and preferably minimized by the use of a signal amplification unit. Operation of the sensor unit independently of the heating unit and therefore continuous determination of the state variable relating to the heating unit can also advantageously be achieved, thereby advantageously improving operating convenience and/or the operating result further for a user.

For example particularly fast and reliable detection of movement of cookware onto a hob plate and automatic adjustment of the heating elements of the heating unit to be operated would also be conceivable during operation. Also the separate configuration of sensor unit and heating unit advantageously allows the use of particularly high-resolution sensor units, allowing further state variables relating to the heating unit, for example the shape and/or size and/or material of the cookware, to be determined in addition to presence and degree of cover.

A “hob apparatus”, in particular an “induction hob apparatus” refers to at least a part, in particular a sub-assembly, of a hob, in particular an induction hob. The hob apparatus could comprise for example at least one positioning plate, in particular at least one hob plate, which could be provided for example to receive cookware, in particular for the purpose of heating the cookware. The hob apparatus, in particular the induction hob apparatus, can also comprise the entire hob, in particular the entire induction hob. The hob apparatus is preferably configured as an induction hob apparatus. Alternatively however it would also be conceivable for the hob apparatus to be part of a different hob type, for example a ceramic hob or the like.

A “heating unit” refers to a unit, which has at least one heating element, which in at least one operating state supplies energy to at least one object, for example cookware. The heating element of the heating unit could be configured for example as a heat radiating heating element for a ceramic hob and could supply energy in the form of heat radiation to the object in the operating state. The heating unit is preferably configured as an induction heating unit and has at least one heating element, which is configured as an induction heating element. The heating element configured as an induction heating element is provided to supply energy in the form of an electromagnetic alternating field, advantageously for the purpose of an inductive energy transfer, to the object in the operating state. The heating unit advantageously has at least two, particularly advantageously at least four, preferably at least eight and particularly preferably a plurality of heating elements. The heating elements of the heating unit could be arranged in a distributed manner, for example in the manner of a matrix.

A “sensor unit” refers to a unit with at least one sensor assembly, which includes at least the electric resonant circuit, at least one signal input connected in an electrically conducting manner to the electric resonant circuit and at least one signal output connected in an electrically conducting manner to the electric resonant circuit and provided for detecting the at least one sensor signal. The electric resonant circuit preferably comprises at least one electrical resistance, at least one induction coil and at least one capacitor. The signal input is preferably configured as an electrical component, in particular as a connection point, for feeding a signal into the electric resonant circuit, in particular for activation by means of the control unit. The signal output is preferably configured as an electrical component, for example as an electrical shunt resistor, at which at least one output signal occurs. That the “sensor unit is provided for detecting the at least one sensor signal” here means that the sensor signal can be measured at at least one electrical component of the sensor unit, in particular the signal input and/or signal output, it being possible for measurement of the sensor signal also to take place at least partially by means of further units of the hob apparatus that are not the sensor unit, in particular by means of the control unit. The sensor signal is preferably an electrical signal, which is present and/or drops and/or flows in the form of an electrical voltage and/or an electrical current, in particular in the form of an electrical AC voltage and/or an electrical alternating current, at the signal input and/or signal output of the sensor assembly and which describes at least one electrical variable of the electric resonant circuit, in particular an equivalent impedance of the electric resonant circuit. The further signal is preferably an electrical signal, which is present and/or drops and/or flows in the form of an electrical voltage and/or an electrical current, in particular in the form of an electrical AC voltage and/or an electrical alternating current, at the signal input and/or signal output of the sensor assembly and which describes at least one electrical variable of the electric resonant circuit, in particular an equivalent impedance of the electric resonant circuit. The sensor unit can have a plurality of sensor assemblies, each being provided for detecting at least one sensor signal. The sensor unit advantageously has a number of sensor assemblies, corresponding at least to the number of heating elements in the heating unit. The sensor unit preferably has a larger number of sensor assemblies than the number of heating elements in the heating unit.

A “control unit” refers to an electronic unit, which is at least partially integrated in the hob apparatus and which is provided at least for activating the sensor unit and for analyzing the sensor signal. The control unit can be connected in an electrically conducting manner to the signal input and/or signal output to control the sensor unit. In addition to controlling the sensor unit, the control unit is also preferably provided to control and supply energy to the heating unit and/or further units of the hob apparatus. To control and supply energy to the heating unit the control unit preferably has at least one inverter unit, which can be configured in particular as a resonance inverter and/or as a dual half-bridge inverter. The inverter unit preferably comprises at least two switching elements, which can be activated individually by the control unit. A “switching element” refers in particular to an element, which is provided to establish and/or break an electrically conducting connection between two points, in particular contacts of the switching element. The switching element preferably has at least one control contact, by way of which it can be switched. The switching element is preferably configured as a semiconductor switching element, in particular a transistor, for example a metal oxide semiconductor field effect transistor (MOFSET) or an organic field effect transistor (OFET), advantageously as a bipolar transistor with a preferably insulated gate electrode (IGBT). Alternatively it is conceivable for the switching element to be configured as a mechanical and/or electromechanical switching element, in particular a relay. To analyze the sensor signal and determine the at least one state variable relating to the heating unit, the control unit preferably comprises at least one computation unit. The control unit preferably comprises at least one storage unit, in which at least one reference signal and preferably at least one algorithm for determining the state variable relating to the heating unit are stored.

The state variable relating to the heating unit could be, without restriction thereto, for example a presence and/or a degree of cover of one or more heating elements of the heating unit and/or a shape and/or size and/or electrical and/or electromagnetic characteristic variable, for example an electrical resistance and/or an inductance of an object, in particular cookware, to which the heating unit supplies the energy in the operating state.

“Provided” means specifically programmed, designed and/or equipped. That an object is provided for a specific function means that the object fulfils and/or executes said specific function in at least one application and/or operating state.

It is further proposed that the hob apparatus comprises a plate unit arranged above the heating unit, including at least part of the sensor unit. The plate unit advantageously allows a particularly powerful, in particular high-resolution, sensor unit to be integrated in the hob apparatus, thereby further improving operating convenience and/or the operating experience for a user of the hob apparatus. The plate unit preferably includes at least the electric resonant circuit of the sensor unit. The plate unit could include for example at least one printed circuit board, to which electrical components of the sensor unit, in particular electrical components of the electric resonant circuit of the sensor unit, are fastened and where they are connected to one another in an electrically conducting manner. The printed circuit board could be for example a surface mounted device or SMD of single layer or multilayer design, produced using an appropriate method. The printed circuit board could be configured as a rigid printed circuit board. Alternatively the printed circuit board could be configured as a flexible printed circuit board, for example a rigid-flexible printed circuit board or a semi-flexible printed circuit board.

In an alternative advantageous embodiment it is proposed that the hob apparatus comprises a holding unit, which attaches at least one heating element of the heating unit and at least one part of the sensor unit to one another. The holding unit attaches the at least one heating element of the heating unit and the at least one part of the sensor unit to one another, in particular relative to a further unit, for example the control unit. Such an embodiment advantageously means that the hob apparatus has a particularly compact and/or economical structure. The holding unit could be configured for example as a coil carrier for receiving and positioning an induction coil of a heating element of the heating unit configured as an induction heating element, which is additionally provided to receive and position at least a part of the sensor unit, for example the induction coil of the electric resonant circuit. Alternatively or additionally it would be conceivable for at least part of the sensor unit to be integrated in an insulating layer of the holding unit, to which the at least one heating element of the heating unit is attached.

It is also proposed that the control unit has at least one signal generation unit, which is provided for generating a signal for controlling the sensor unit. This advantageously allows particularly reliable and less error-prone control of the sensor unit. The signal is preferably an input signal, which can be supplied to the at least one signal input of the sensor unit. The signal generation unit is configured as a different unit from the inverter unit. The signal generated by means of the signal generation unit differs from an inverter signal, which is generated by an inverter of the inverter unit to activate and supply energy to a heating element of the heating unit, at least in respect of frequency. The signal generated by means of the signal generation unit is preferably a high-frequency signal with a higher frequency than the inverter frequency of the inverter signal for activating and supplying energy to a heating element of the heating unit. For example the frequency of the signal is a factor of at least 2, advantageously a factor of at least 3, particularly advantageously a factor of at least 4, preferably a factor of at least 5 and particularly preferably a factor of at least 10 greater than the inverter frequency. For example the frequency of the signal is at least 1 MHz, advantageously at least 2 MHz, particularly advantageously at least 5 MHz, preferably at least 10 MHz and particularly preferably at least 20 MHz. This advantageously further minimizes electromagnetic interactions between the sensor unit and the heating unit and associated potential detection errors. The signal generation unit is preferably provided for digital signal generation. The signal generation unit could include for example a synthesizer with direct digital synthesis (DDS) and a digital/analog converter (DAC) for generating the signal, these being configured in particular as integrated circuits (IC). The signal generation unit could also include for example what is known as an R2R resistor network and/or an analog multiplexer or a digital multiplexer. Alternatively it would be conceivable for the signal to be generated as a rectangular signal by means of a microprocessor of the control unit and then to be filtered by means of a filter, for example by means of a serial RLC circuit, and converted to a sinusoidal signal.

It is also proposed that the control unit has a signal amplification unit for amplifying the signal and for increasing the signal to noise ratio in respect of interference signals. This advantageously further improves detection of the sensor signal and further minimizes the occurrence of detection errors. Without restriction hereto the signal amplification unit could include for example a differential amplifier and/or an operational amplifier and/or an impedance converter for amplifying the signal.

It is further proposed that the signal has a frequency which corresponds substantially to a resonant frequency of the resonant circuit. Such an embodiment advantageously further improves the determination of the state variable relating to the heating unit by the control unit. If the frequency of the signal corresponds at least substantially to the resonant frequency of the resonant circuit, a particularly informative sensor signal can advantageously be detected, thereby allowing particularly accurate determination of the state variable relating to the heating unit. The resonant frequency is a variable relating to a reference state of the resonant circuit. The frequency of the signal, which corresponds at least substantially to the resonant frequency of the resonant circuit, deviates from the value of the resonant frequency as a maximum by 10%, advantageously as a maximum by 5%, preferably as a maximum by 2% and particularly preferably as a maximum by 1%. Alternatively it would be conceivable for the signal to have a frequency which is greater or smaller than the resonant frequency of the electric resonant circuit.

It is also proposed that a reference signal, which comprises a difference between at least one variable of the sensor signal and at least one variable of the further signal measured in a reference state, is stored in the control unit. This advantageously allows particularly accurate and/or reliable determination of the at least one state variable relating to the heating unit. A “reference signal” refers to a signal, which can be detected at the sensor unit in a reference state. The reference state here is a state, in which the hob apparatus, in particular the sensor unit of the hob apparatus, is operated in the absence of external influences, in particular in the absence of an external object, for example cookware, which would influence the signal. The variable of the signal and/or the further signal can be for example a phase of a voltage and/or a current and/or an amplitude of a voltage and/or a current. The difference between the variable of the sensor signal and the variable of the further signal here can be a difference between two variables of the same type, for example a difference between an amplitude of a voltage of the sensor signal and an amplitude of a voltage of the further signal, or a difference between two different variables, for example a difference between a phase angle of a voltage of the sensor signal and a phase angle of a current of the further signal.

It is also proposed that the control unit has at least one detection unit for detecting the phase shift and/or an amplitude. This advantageously allows particularly reliable and/or accurate detection of the phase shift and/or amplitude. The detection unit can be configured as an analog phase comparator, for example an analog multiplier or a fully symmetrical mixer or a diode mixer, and be provided for analog detection of the phase shift and/or amplitude. Alternatively the detection unit could be configured as a digital phase comparator and/or a digital amplitude comparator, with digital detection of the phase shift and/or amplitude being able to take place based on a previously converted rectangular signal for example by means of an XOR gate or a flip-flop circuit or the like.

It is also proposed that the detection unit is configured as a lock-in amplifier. This advantageously increases a signal to noise ratio, thereby further reducing any tendency to error during detection. The detection unit configured as a lock-in amplifier is preferably provided also to detect an amplitude of the sensor signal and an amplitude of the further signal, in particular the reference signal, in addition to detecting the phase shift. An impedance and therefore an equivalent resistance and an equivalent inductance of cookware used can be calculated, preferably by the control unit, based on the phase shift detected by means of the detection unit configured as a lock-in amplifier and the detected amplitude of the sensor signal and an amplitude of the further signal, in particular the reference signal. This advantageously further improves operation, by allowing for example activation of the heating unit by the control unit tailored specifically to specific cookware.

It is also proposed that, to determine the state variable in the operating state, the control unit compares a phase angle of the sensor signal with a phase angle of the further signal, in particular the reference signal, and/or an amplitude of the sensor signal with an amplitude of the further signal, in particular the reference signal. Determination of the state variable relating to the heating unit can advantageously be achieved with simple means using such an embodiment. The comparison of the phase angle and/or amplitude of the sensor signal with the phase angle and/or amplitude of the further signal, in particular the reference signal, preferably takes place using the detection unit of the control unit.

In an alternative advantageous embodiment it is proposed that, to determine the state variable in the operating state, the control unit varies the frequency of the signal until a phase angle of the sensor signal and a phase angle of the reference signal correspond. Such an embodiment advantageously provides a further option for determining the state variable. The control unit preferably varies the frequency of the signal by means of the signal generation unit in the operating state until the phase angle of the sensor signal corresponds to the phase angle of the reference signal, stores the frequency required for phase angle correspondence, compares this, in particular by means of an algorithm stored in the storage unit, with the resonant frequency in the reference state and determines the state variable relating to the heating unit therefrom.

The invention also relates to a hob with a hob apparatus according to one of the embodiments cited above. Such a hob is characterized inter alia by the advantageous properties of the hob apparatus cited above and the associated benefits for a user in respect of improved operating convenience and/or an improved operating experience.

The invention is also based on a method for operating a hob apparatus with at least one heating unit and at least one sensor unit that is separate from the heating unit and has at least one electric resonant circuit.

It is proposed that at least one sensor signal is detected and at least one state variable relating to the heating unit is determined based on a phase shift and/or an amplitude ratio between the sensor signal and a further signal, in particular a stored reference signal. Because the state variable relating to the heating unit is determined based on a phase shift and/or an amplitude ratio between the sensor signal and a further signal, in particular a stored reference signal, it is advantageously possible to determine the state variable in a less error-prone, accurate manner that is particularly reliable, in particular when compared with conventional methods in which a state variable is determined based on a detected frequency.

The hob apparatus here should not be restricted to the application and embodiment described above. In particular the hob apparatus can have a number of individual elements, components and units that is different from the number cited herein to comply with a mode of operation described herein.

Further advantages will emerge from the description of the drawing that follows. The drawing shows three exemplary embodiments of the invention. The drawing, description and claims contain numerous features in combination. The person skilled in the art will expediently also consider the features individually and combine them in meaningful further combinations.

In the drawing:

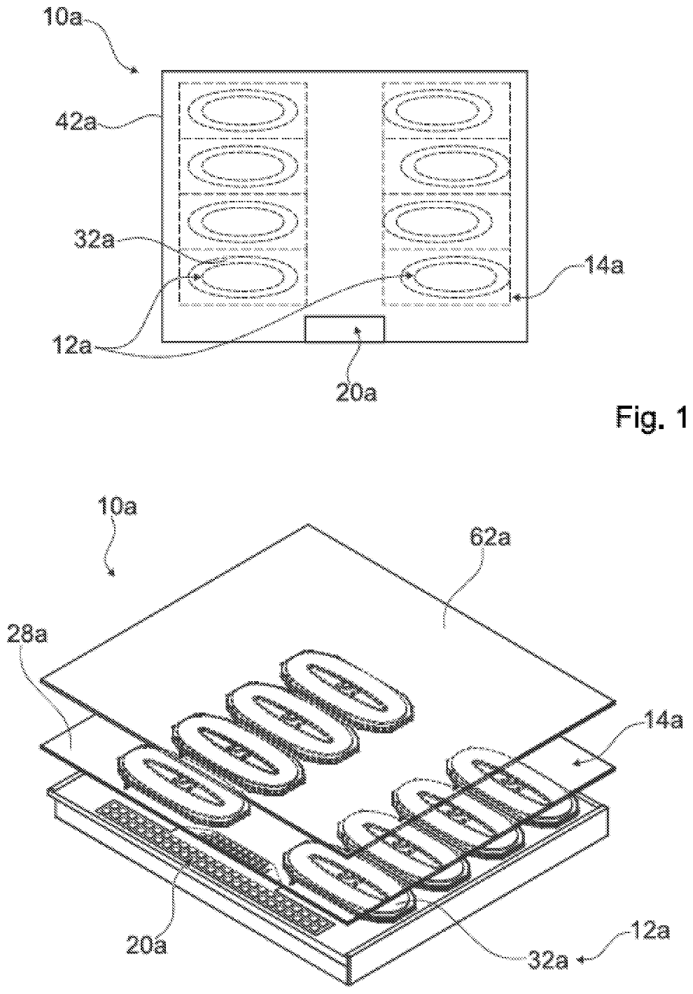

FIG. 1 shows a schematic top view of a hob with a hob apparatus, comprising a heating unit, a sensor unit and a control unit,

FIG. 2 shows a schematic exploded view of the hob apparatus with a plate unit arranged above the heating unit,

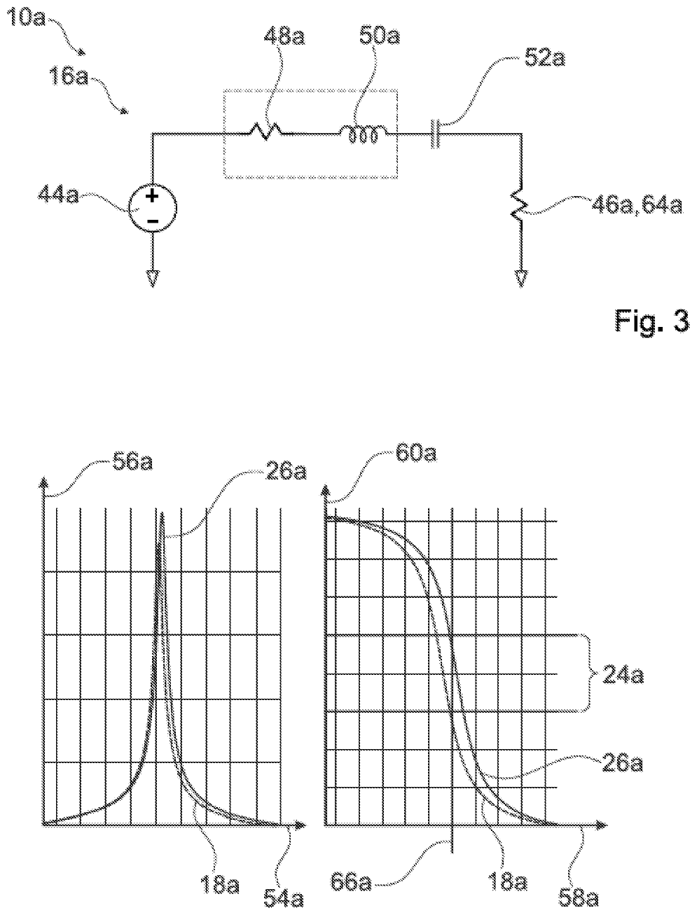

FIG. 3 shows a schematic electrical circuit diagram of an electric resonant circuit of the sensor unit,

FIG. 4 shows two schematic diagrams of a sensor signal detected by the sensor unit and a reference signal,

FIG. 5 shows a schematic diagram of the control unit,

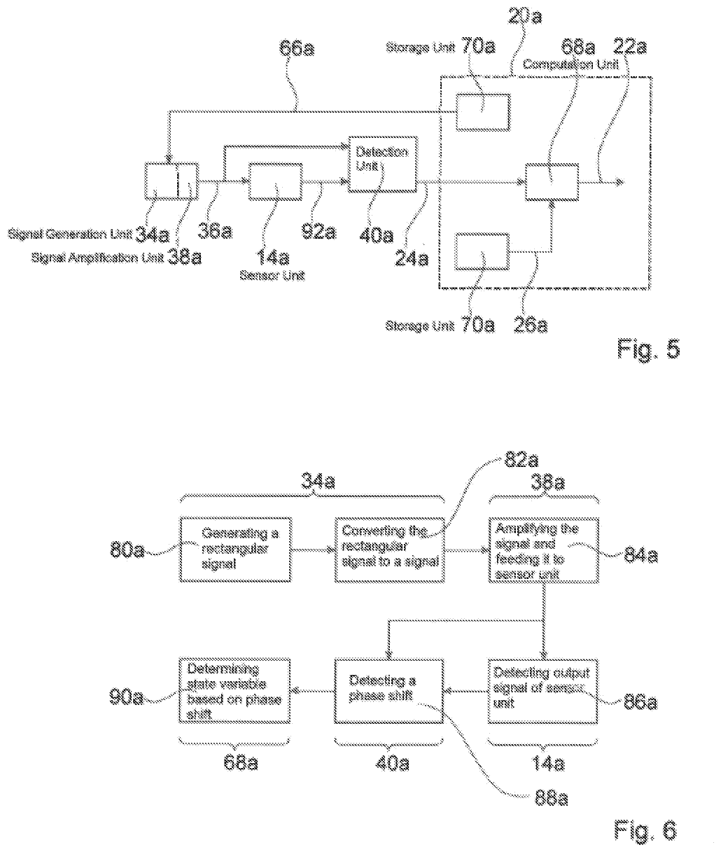

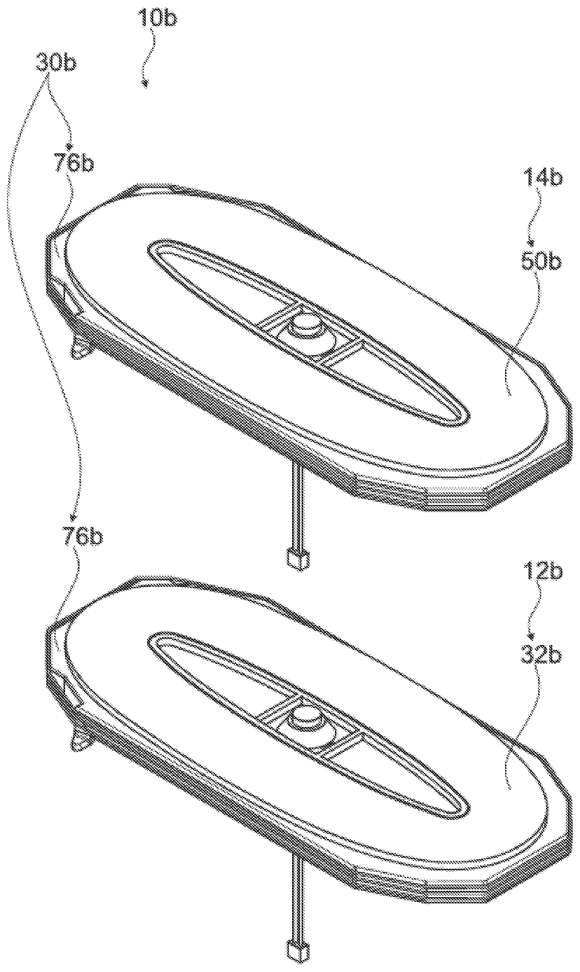

FIG. 6 shows a schematic flow diagram of a method for operating the hob apparatus,

FIG. 7 shows a schematic diagram of a holding unit for a further exemplary embodiment of a hob apparatus, and

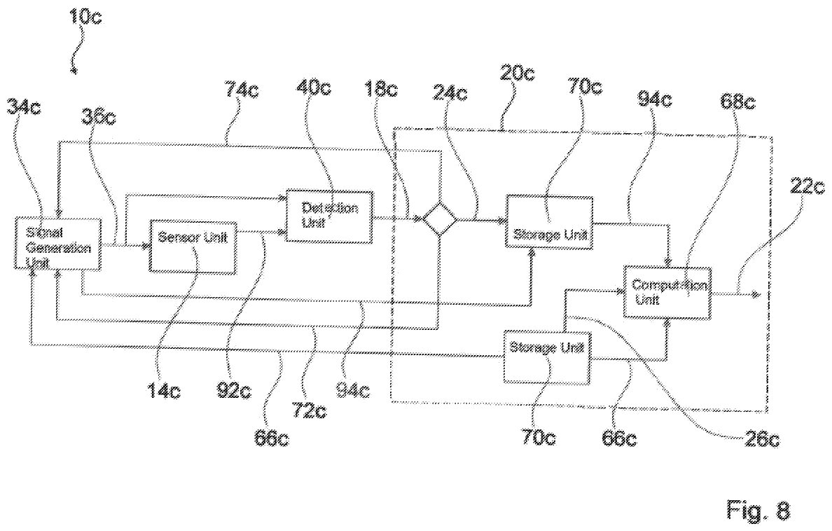

FIG. 8 shows a schematic diagram of a control unit for a further exemplary embodiment of a hob apparatus.

FIG. 1 shows a schematic top view of a hob 42a. The hob 42a is configured as an induction hob. The hob 42a has a hob apparatus 10a. The hob apparatus 10a is configured as an induction hob apparatus. The hob apparatus 10a comprises a heating unit 12a. The heating unit 12a has a plurality of heating elements 32a, each of which is configured as an induction heating element.

Where a number of objects is present only one is shown with a reference character in the figures.

The hob apparatus 10a comprises a sensor unit 14a. The sensor unit 14a is separate from the heating unit 12a. The sensor unit 14a has an electric resonant circuit 16a (see FIG. 3). The sensor unit 14a is provided for detecting a sensor signal 18a (see FIG. 4).

The hob apparatus 10a comprises a control unit 20a. The control unit 20a is provided for controlling the sensor unit 14a. The control unit 20a is provided for analyzing the sensor signal 18a. When the hob apparatus 10a is in an operating state the control unit 20a determines at least one state variable 22a relating to the heating unit 12a (see FIG. 5) based on a phase shift 24a and/or an amplitude ratio between the sensor signal 18a and a further signal.

A reference signal 26a is stored in the control unit 20a. The reference signal 20a comprises a difference between a variable of the sensor signal 18a and a variable of the further signal measured in a reference state. The variable of the sensor signal 18a here is a phase angle and the variable of the further signal is a further phase angle.

FIG. 2 shows a schematic exploded view of the hob apparatus 10a. The hob apparatus 10a has a plate unit 28a. When the hob apparatus 10a is in an assembled state, the plate unit 28a is arranged above the heating unit 12a and below a hob plate 62a of the hob 42a. The plate unit 28a includes at least part of the sensor unit 14a. The plate unit 28a includes the resonant circuit 16a of the sensor unit 14a. The resonant circuit 16a of the sensor unit 14a is attached to a printed circuit board, which is connected to the plate unit 28a.

FIG. 3 shows a schematic electrical circuit diagram of the sensor unit 14a. The sensor unit 14a comprises the electric resonant circuit 16a. The sensor unit 14a comprises a signal input 44a and a signal output 46a, each of which is connected in an electrically conducting manner to the electric resonant circuit 16a. The electric resonant circuit 46a comprises an electrical resistance 48a, an induction coil 50a and a capacitor 52a.

The signal input 44a of the sensor unit 14a is connected in an electrically conducting manner to a signal amplification unit 38a and to a signal generation unit 34a of the control unit 20a. In an operating state a signal generated by means of the signal generation unit 34a and amplified by means of the signal amplification unit 38a is fed into the electric resonant circuit 16a by way of the signal input 44a. The signal output 46a is configured as an electrical shunt resistor 64a.

FIG. 4 shows two diagrams. A frequency in megahertz is shown on an x-axis 54a of the left-hand diagram. A value of an impedance in ohms is shown on a y-axis 56a of the left-hand diagram. The left-hand diagram shows the reference signal 26a with a solid line. The left-hand diagram shows the sensor signal 18a with a broken line. The value of the impedance of the reference signal is at a maximum at a resonant frequency 66a of the resonant circuit.

The frequency in megahertz is shown on an x-axis 58a of the right-hand diagram. A phase angle is shown on a y-axis 60a of the right-hand diagram. The right-hand diagram shows the reference signal 26a with a solid line. The left-hand diagram shows the sensor signal 18a with a broken line. A phase angle of the reference signal 26a, which can be measured in the electric resonant circuit 16a of the sensor unit 14a in a reference state at the resonant frequency 66a, is for example 20°. A phase angle of the sensor signal 18a, which can be measured in the electric resonant circuit 16a of the sensor unit 14a when the hob apparatus 10a is in an operating state, in which cookware (not shown) is positioned above the sensor unit 14a, at the resonant frequency 66a, is for example −20°. This results in the phase shift 24a, in this example 40°.

The sensor signal 18a describes a ratio between a signal 36a (see FIG. 5) and an output signal 92a of the electric resonant circuit 16a and can be considered as an equivalent impedance of the electric resonant circuit 16a in the operating state. The reference signal 26a can be considered as an equivalent impedance of the electric resonant circuit 16a in the reference state.

FIG. 5 shows a schematic diagram of the control unit 20a. The control unit 20a includes the signal generation unit 34a. The signal generation unit 34a is provided for generating the signal 36a for controlling the sensor unit 14a.

The control unit 20a includes the signal amplification unit 38a. The signal amplification unit 38a is provided for amplifying the signal 36a and increasing a signal to noise ratio in respect of interference signals. Interference signals could be caused in the operating state for example by an electromagnetic field supplied by a heating element 32a of the heating unit 12a for heating purposes.

In the operating state the signal 36a generated by means of the signal generation unit 34a and amplified by means of the signal amplification unit 38a is fed into the electric resonant circuit 16a of the sensor unit 14a by way of the signal input 44a (see FIG. 3). The signal 36a has a frequency, which corresponds substantially to the resonant frequency 66a of the electric resonant circuit 16a. The resonant frequency 66a is stored in a storage unit 70a of the control unit 20a and is sent to the signal generation unit 34a for generating the signal 36a in the operating state.

The control unit 20a has a detection unit 40a. The detection unit 40a is provided for detecting the phase shift 24a and/or an amplitude. The detection unit 40a is configured as a lock-in amplifier. A voltage dropping at the signal output 46a configured as an electrical shunt resistor 64a in the operating state can be detected as the output signal 92a and is sent to the detection unit 40a. The signal 36a is also sent to the detection unit 40a.

To determine the state variable 24a in the operating state the control unit 20a compares a phase angle and/or amplitude of the sensor signal 18a and a phase angle and/or amplitude of the reference signal 26a. In the present exemplary embodiment the phase angle comparison is carried out by means of the detection unit 40a. In the operating state the detection unit 40a detects the phase shift 24a and sends this to the computation unit 68a of the control unit 20a. The reference signal 26a is stored in the storage unit 70a. In the operating state the computation unit 68a accesses the storage unit 70a and determines the state variable based on the phase shift 24a between the sensor signal 18a and the further signal. In the present exemplary embodiment the state variable 24a contains for example information about a degree of cover of a heating element 32a of the heating unit 12a (see FIG. 1) by cookware (not shown).

FIG. 6 shows a schematic flow diagram of a method for operating the hob apparatus 10a. In the method the at least one sensor signal 18a is detected and at least the state variable 22a relating to the heating unit 12a is determined based on the phase shift 24a and/or amplitude ratio between the sensor signal 18a and the further signal, which is stored as the reference signal 26a in the control unit. The method comprises a number of method steps. In a method step 80a a microprocessor in the signal generation unit 34a generates a rectangular signal. In a further method step 82a the rectangular signal is converted to the signal 36a by means of the signal generation unit 34a. The signal 36a is now sinusoidal and is sent to the signal amplification unit 38a. In a further method step 84a the signal 36a is amplified and then fed into the electric resonant circuit 16a of the sensor unit 14a by way of the signal input 44a (see FIG. 3) and sent to the detection unit 40a. In a further method step 86a the output signal 92a at the signal output 46a of the electric resonant circuit is detected and sent to the detection unit 40a. In a further method step 88a the detection unit 40a detects the phase shift 24a between the sensor signal 18a and the stored further signal and sends this to the computation unit 68a of the control unit 20a. In a further method step 90a the computation unit 68a determines the state variable 22a based on the phase shift 24a.

FIGS. 7 and 8 show two further exemplary embodiments of the invention. The descriptions that follow are restricted substantially to the differences between the exemplary embodiments, it being possible to refer to the description of the exemplary embodiment in FIGS. 1 to 6 for components, features and functions that remain the same. To distinguish between the exemplary embodiments the letter a in the reference characters of the exemplary embodiment in FIGS. 1 to 6 is replaced by the letters b and c in the reference characters of the exemplary embodiments in FIGS. 7 and 8. Reference can also be made in principle to the drawings and/or the description of the exemplary embodiment in FIGS. 1 to 6 for components of identical designation, in particular for components with identical reference characters.

FIG. 7 shows a schematic diagram of a holding unit 30b of a hob apparatus 10b. The hob apparatus 10b has a sensor unit 14b and a heating unit 12b. The holding unit 30b attaches a heating element 32b of the heating unit 12b and at least a part of the sensor unit 14b to one another. The hob apparatus 10b differs from the hob apparatus 10a of the preceding exemplary embodiment substantially in respect of an arrangement of the sensor unit 14b. Reference should be made here to the above description of the exemplary embodiment in FIGS. 1 to 6 for a mode of operation of the hob apparatus 10b.

The holding unit 30b comprises a first holding element 76b and a second holding element 78b. An induction coil 50b of the sensor unit 14b is attached to the first holding element 76b of the holding unit 30b. The heating element 32b of the heating unit 12b is attached to the second holding element 78b of the holding unit 30b. The first holding element 76b and the second holding element 78b are connected to one another and form the holding unit 30b in an assembled state.

FIG. 8 shows a further exemplary embodiment of a hob apparatus 10c. The hob apparatus 10c differs from the hob apparatus 10a of the exemplary embodiment in FIGS. 1 to 6 substantially in respect of an embodiment of a control unit 20c. Reference should be made here to the above description of the exemplary embodiment in FIGS. 1 to 6 for further components of the hob apparatus 10c.

FIG. 8 shows a schematic diagram of the control unit 20c. When the hob apparatus 10c is in an operating state, the control unit 20c determines at least one state variable 22c based on a phase shift 24c between a sensor signal 18c and a stored reference signal 26c. When the hob apparatus 10c is in the operating state the control unit 20c determines the state variable 22c by varying a frequency 94c of a signal 36c until a phase angle of the sensor signal 18c and a phase angle of the reference signal 26c correspond.

The control unit 20c has a signal generation unit 34c, which is provided for generating the signal 26c for controlling a sensor unit 14c. When the hob apparatus 10c is in the operating state, the signal generation unit 34c generates the signal 36c initially based on a resonant frequency 66c stored in a storage unit 70c of the control unit 20c and sends the signal 36c to the sensor unit 14c and a detection unit 40c of the control unit 20c. The detection unit 40c determines the phase shift 24c from the signal 36c and an output signal 92c of the sensor unit 14c. While the phase shift 24c has a value that is not zero, the control unit 20c varies the frequency 94c, by sending either a frequency decrease 72c or a frequency increase 74c to the signal generation unit 34c. When the phase angle of the sensor signal 18c and the phase angle of the reference signal 26c correspond, in other words the phase shift 24c is zero, the control unit 20c stores the associated frequency 94c in the storage unit 70c. A computation unit 68c of the control unit 20c accesses the storage unit 20c, compares the frequency 94c with the resonant frequency 66c and determines the state variable 22 therefrom.

### REFERENCE CHARACTERS

10 Hob apparatus
12 Heating unit
14 Sensor unit
16 Resonant circuit
18 Sensor signal
20 Control unit
22 State variable
24 Phase shift
26 Reference signal
28 Plate unit
30 Holding unit
32 Heating element
34 Signal generation unit
36 Signal
38 Signal amplification unit
40 Detection unit
42 Hob
44 Signal input
46 Signal output
48 Electrical resistance
50 Induction coil
52 Capacitor
54 x-axis
56 y-axis
58 x-axis
60 y-axis
62 Hob plate
64 Electrical shunt resistor
66 Resonant frequency
68 Computation unit
70 Storage unit
72 Frequency decrease
74 Frequency increase
76 Holding element
78 Holding element
80 Method step
82 Further method step
84 Further method step
86 Further method step
88 Further method step
90 Further method step
92 Output signal
94 Frequency

1-13. (canceled)

14. A hob apparatus, comprising:
a heating unit;
a sensor unit separate from the heating unit, said sensor unit configured to include an electric resonant circuit and to detect a sensor signal; and
a control unit configured to control the sensor unit and to analyze the sensor signal, said control unit determining in an operating state a state variable relating to the heating unit based on a phase shift and/or an amplitude ratio between the sensor signal and a further signal.

15. The hob apparatus of claim 14, embodied as an induction hob apparatus.

16. The hob apparatus of claim 14, further comprising a plate unit arranged above the heating unit and including at least part of the sensor unit.

17. The hob apparatus of claim 14, further comprising a holding unit configured to attach a heating element of the heating unit and at least one part of the sensor unit to one another.

18. The hob apparatus of claim 14, wherein the control unit includes a signal generation unit to generate a signal for controlling the sensor unit.

19. The hob apparatus of claim 18, wherein the control unit includes a signal amplification unit for amplifying the signal and for increasing the signal to noise ratio in respect of an interference signal.

20. The hob apparatus of claim 18, wherein the signal has a frequency which corresponds substantially to a resonant frequency of the resonant circuit.

21. The hob apparatus of claim 14, wherein the control unit is configured to store a reference signal, which comprises a difference between a variable of the sensor signal and a variable of the further signal measured in a reference state.

22. The hob apparatus of claim 14, wherein the control unit includes a detection unit for detecting the phase shift and/or an amplitude.

23. The hob apparatus of claim 22, wherein the detection unit is configured as a lock-in amplifier.

24. The hob apparatus of claim 14, wherein the control unit is configured in at least one of two ways for determining the state variable in the operating state, a first way in which the control unit compares a phase angle of the sensor signal with a phase angle of the further signal, a second way in which the control unit compares an amplitude of the sensor signal with an amplitude of the further signal.

25. The hob apparatus of claim 21, wherein the control unit is configured to vary the frequency of the signal until a phase angle of the sensor signal and a phase angle of the reference signal correspond for determining the state variable in the operating state.

26. A hob, comprising a hob apparatus, said hob apparatus comprising a heating unit, a sensor unit separate from the heating unit and configured to include an electric resonant circuit and to detect a sensor signal, and a control unit configured to control the sensor unit and to analyze the sensor signal, wherein the control unit determines in an operating state a state variable relating to the heating unit based on a phase shift and/or an amplitude ratio between the sensor signal and a further signal.

28. A method for operating a hob apparatus including a heating unit and a sensor unit arranged separate from the heating unit and including an electric resonant circuit, said method comprising:
detecting by the sensor unit a sensor signal; and
determining a state variable relating to the heating unit based on a phase shift and/or an amplitude ratio between the sensor signal and a further signal.

29. The method of claim 28, further comprising generating with a signal generation unit a signal for controlling the sensor unit.

30. The method of claim 28, further comprising storing a reference signal, which comprises a difference between a variable of the sensor signal and a variable of the further signal measured in a reference state.

31. The method of claim 28, further comprising detecting the phase shift and/or an amplitude.

32. The method of claim 28, further comprising comparing a phase angle of the sensor signal with a phase angle of the further signal and/or an amplitude of the sensor signal with an amplitude of the further signal for determining the state variable in the operating state.

33. The method of claim 30, further comprising varying a frequency of the signal until a phase angle of the sensor signal and a phase angle of the reference signal correspond for determining the state variable in the operating state.
